(19) United States
(12) Patent Application Publication
(10) Pub. No.: US 2014/0332646 A1
(43) Pub. Date: Nov. 13, 2014

(54) Universal Holder for Bottles, Bowls, Pacifiers, Toys and Merchandise

(71) Applicants: Leif Soderlind, Palm Desert, CA (US); Michelle Soderlind, Palm Desert, CA (US)

(72) Inventors: Leif Soderlind, Palm Desert, CA (US); Michelle Soderlind, Palm Desert, CA (US)

(21) Appl. No.: 13/890,243

(22) Filed: May 8, 2013

(51) Int. Cl. F16M 13/04

(52) U.S. Cl. CPC F16M 13/04
USPC 248/205.1

(57) ABSTRACT

the universal holder comprises a base and stand with arms to hold a baby bottle, cup, bowl, teether, toy, game or other merchandise within reach of a seated infant or child.

### PRIORITY CLAIM

This application claims the benefit under 35 U.S.C. Section 119(e) of U.S. Provisional Application No. 61/644,449 filed May 9, 2012 which is hereby incorporated by reference in its entirety.

### COPYRIGHT RIGHTS

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### FIELD OF THE INVENTION

This invention relates to holders for baby bottles, bowls, teethers, toy, games and other merchandise.

### DEFINITIONS

The following abbreviations and defined terms apply to methods or systems of the inventions described in this document.

The term “bottle” means any container of any type or kind whatsoever for storing and/or drinking of liquid including bottles with nipples, bottle or cups with lids having valves for sipping, bottles or cups with straws or other bottle or container that can be handheld by a human including but not limited to bottles with or without necks, bottles with or without a concave or hour-glass shape, bottles that are round, bottles that are polygons in cross-section, sacks filled with liquid, bottles or sacks inserted within a sleeve or pocket, and so on.

The term “bowl” means any container of any type or kind whatsoever for storing and/or dispensing of food including but not limited to containers with or without lids or covers for holding of finger food, and sacks for holding of mashed food or food with a paste-like consistency, and so on.

The term “pacifier” means any device of any type or kind whatsoever, other than a bottle, to be inserted in the mouth of an infant or child, said device having a teat, nipple or like protrusion and a mouth shield to prevent choking and/or swallowing of the device.

The term “teether” means any device of any type or kind whatsoever, other than a bottle or pacifier, to be inserted in the mouth of an infant or child, said device having a portion for gripping and/or chewing with teeth of an infant or child and the device having a sufficient size to prevent fully inserting the device in the mount of the infant or child.

The term “toy” means any tangible object of any type or kind whatsoever for play, entertainment and/or education of an infant or child including but limited to a rattle, mobile, doll, stuffed animal, book, drawing pad with or without pen, musical instrument, and so on. A “toy” also means a tangible object that is a component of an entertainment system, said component being an input device, output device, or a combination of input device and output device.

The term “display” means any output device of any kind or type whatsoever capable of displaying numerals, text, graphics, images and/or video including but not limited to a flat panel display (FPD) that comprises a liquid crystal display (LCD) or light emitting diode (LED) screen or a combinations of LCD-LED or a screen with one or more predetermined cutouts and backlit by artificial light sources for each cutout, a heads-up display reflected on a transparent surface, and so on. A “display” also means a lithographic display of the kind known as Etch-a-Sketch® manufactured by Ohio Art Company or a magnetophoretic display panel used with a magnetic pen of the kind manufactured under brand u

The term “entertainment system” means any type of entertainment system whatsoever including but not limited a radio with or without a separate input device or a separate output device, a MP3 player with or without a separate input device or a separate output device, a video or DVD player with or without a separate input device or a separate output device, a read along book system with or without a separate input device or separate output device, a computer game system with or without a separate input device or a separate output device, and so on.

The term “input device” means any tangible device (also known as a ‘control’ or ‘controller’) capable of receiving input from a human. For example, an input device may be a wired control or a wireless remote control, e.g. a radio tuner, a TV remote control, a video game controller, and so on.

The term “output device” means any device capable of displaying or playing information or media for a human. For example, an output device may be one or more speakers, one or more flat panel displays, or a combination of speakers and displays, and so on.

The term “article of merchandise” means any physical good or other tangible object of any type or kind whatsoever including but not limited to a bottle, cup, and/or container, pacifier or teether, toy and/or stuffed animal, keyboard and/or input device, display and/or output device, and any other type of merchandise.

### SUMMARY OF THE INVENTION

A primary object of the present invention is to hold a bottle, bowl, pacifier, teether, toy, book, display, a component of an entertainment system, or other article of merchandise within reach of the infant, child, or seated person.

Another object of the present invention is to support all or a portion of the weight of a bottle, toy, book, display, game controller, or component of an entertainment system, or other article of merchandise that is positioned in front of an infant, child, or seated person.

Another object of the present invention is to increase safety by avoiding the distraction to a car driver of an infant or child having dropped a bottle, toy, or other tangible object which is now out of reach of the infant or child who may call out to the driver.

Still another object of the present invention is provide a neck rest or pillow to support the head or upper torso of the infant or child when seated.

The prior art illustrates holders of bottles which present safety issues or have practical disadvantages including installation time. Several holders of bottles in the prior art suspend the bottle from a structure above. This suspended type of holder creates a natural pendulum and can not be used when the car is in motion for safety reasons due to the imparting of motion to the pendulum which can repeatedly hit the face of the baby or child. Another type of holder encircles the infant or child's neck similar to a bib. This bib type holder does not allow the baby or child to push the bottle away when done feeding or when necessary to avoid choking. Still another type including U.S. Pat. No. 5,192,041 to Bryant and U.S. Pat. No. 7,861,985 to Galvin teach use of a flexible gooseneck for positioning and holding a bottle and merchandise in front of a human. The gooseneck type of holder is impractical due the time required for both installation of gooseneck and the time required to secure the bottle as well as the fact that if the seated person pushes away the bottle or article of merchandise, it will not return to its earlier position. The current invention overcomes the problem of devices in the prior art.

### BRIEF DESCRIPTION OF THE DRAWINGS

FIG. 1A is a perspective drawing of an embodiment of the present invention with the clasping hands in the open position.

FIG. 1B is a perspective drawing of an embodiment of the present invention with the clasping hands in the closed position.

FIG. 2A is a perspective drawing of an alternative embodiment of the present invention with an extension to receive larger tangible objects and the clasping hands in the open position.

FIG. 2B is a perspective drawing of an alternative embodiment of the present invention with an extension to receive larger tangible objects and the clasping hands in the closed position.

FIGS. 3A and 3B are perspective drawings of an alternative embodiment of the present invention with a base having a single leg.

FIG. 4 is a perspective drawing of an alternative embodiment of the present invention have an extendable upright element or stand.

FIG. 5 is a perspective drawing of an alternative embodiment of the present invention showing a stiffening insert in the upright element.

FIG. 6 is an exploded view of the alternative embodiment of the invention shown in FIG. 6 showing device prior to insertion of the stiffener.

FIGS. 7A , 7B and 7C are cross-sections alternative embodiments of the upright element or stand.

FIG. 8 is a side view of an embodiment of the invention with the clasping arms encircling the neck of an adapter that can be removably attached to an article of merchandise.

### DETAILED DESCRIPTION OF THE INVENTION

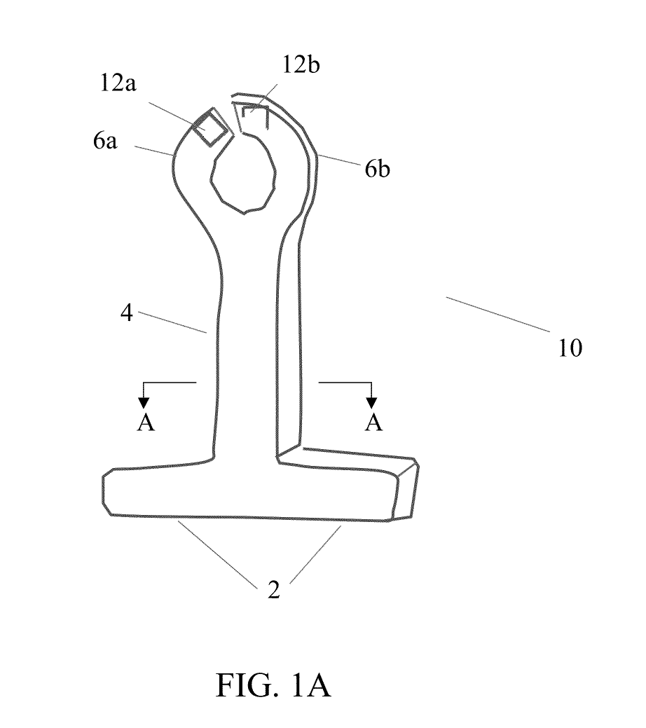

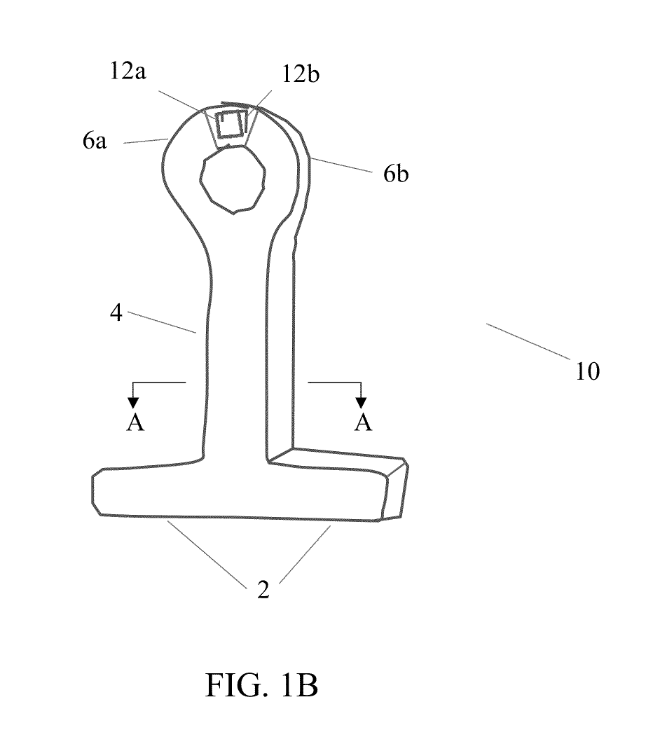

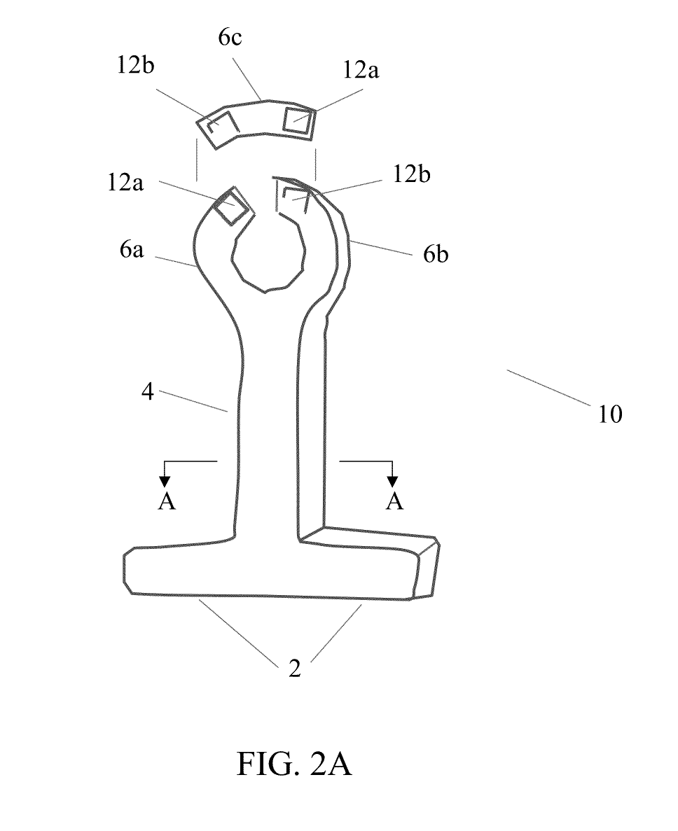

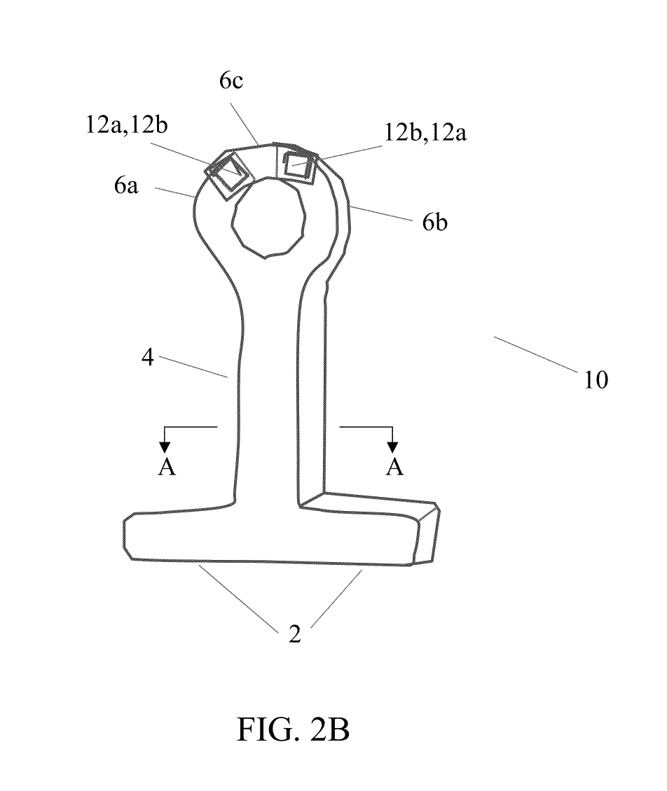

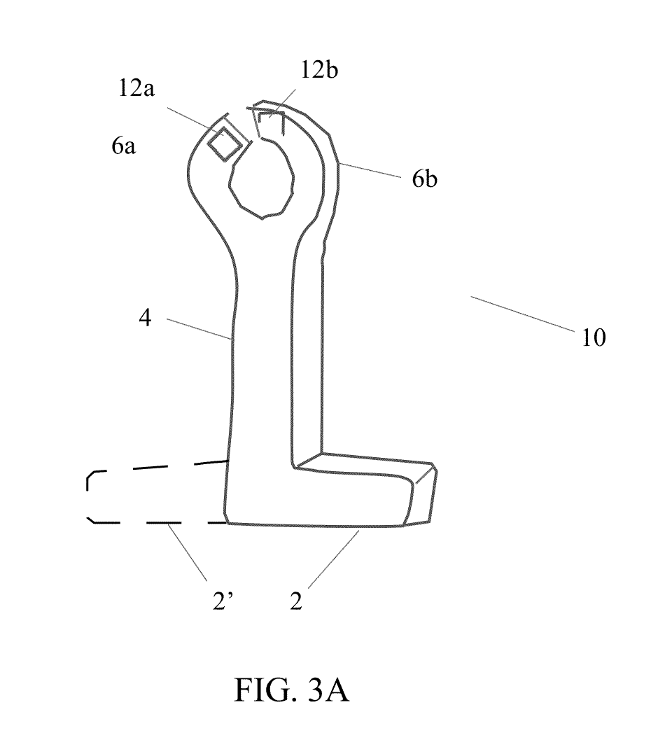

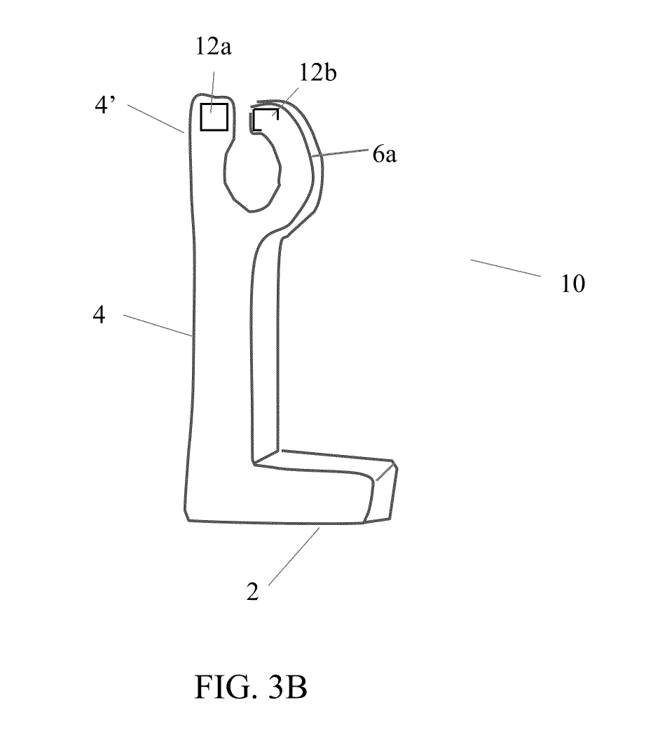

With reference to FIGS. 1 through 4, there are various embodiments of the present invention and each of the elements of the present invention are depicted in the drawings and are referenced by numerals. The present invention includes one or more horizontal elements 2 (and/or 2′), an upright element 4, one or more clasping arms 6a and/or 6b, one or more attachment means 12a, 12b.

One or more horizontal elements 2 (and/or 2′) represents the base or foundation of the device and are anchored under the legs of the seated person either under the knee(s) or upper leg(s). The horizontal element 2 (and/or 2′) provides stability for the device/invention. Each of these horizontal elements can range from 3 inches to 12 inches in horizontal length and 1 inch to 4 inches in height. In many embodiments, the device 10 and the horizontal leg rests are sized for an infant or child. The horizontal elements are situated under the infant or child's legs to secure the device in position when the infant or child rests his or her legs on the seat clamping the horizontal elements.

The upright element 4 is used for support of the bottle or other merchandise in the clasping arms 6a and/or 6b. The upright element can range from 4 inches to 15 inches in height and 1 inch to 6 inches in width and 1 inch to 4 inches in depth. The upright element can support bottle, toy, stuffed animal or other article of merchandise equivalent in weight to a bottle or container with a minimum of 8 fluid oz without showing signs of buckling. In one embodiment, the upright element has a cross-sectional area of between 5 to 7 square inches and an oblong shape. The upright element is connected to the horizontal elements 2 (and/or 2′). The horizontal elements are situated beneath the legs of the seated infant or child and the upright element is situated between the infant or child's legs up with the top of the upright element 4 is in front of the infant or child, where the clasping arms 6a and/or 6b, are in front of the infant or child's face.

In some embodiments, the clasping arms 6a and 6b, consist of two half circular arms that clasp together with the use of Velcro to hold in place. The infant or child's bottle or article of merchandise is then positioned between the arms connected to the upright element 4, and then clasped together with the use of the Velcro to flexibly hold the bottle or other merchandise in position where the merchandise may be moved toward the infant or child with no or very limited horizontal resistance, just support of the weight of the merchandise. In the preferred embodiment, the clasping arms 6a and 6b encircle the bottle or article of merchandise at a neck or a portion which is narrower in diameter or girth than adjacent portions of the bottle or article of merchandise. In some embodiments, the merchandise is a bottle with a nipple and then the nipple of the infant or child's bottle can be inserted into the infant or child's mouth with no restriction, just support for the weight of the bottle. From the upright element 4 to the tips of the clasping arms are from 1 inch to 8 inches in length and ½ inch to 2 inches in width. The Velcro is located on opposite sides of each arm to enable correct clasping.

In some embodiments of the device 10, a shell 18 is stuffed with filling 20 and the shell is permanently sealed. For example, the shell 18 may be stitched closed with thread. For example, filling 20 may be polyester or equivalent to hold the shape. In other embodiments, the shell 18 is openable using a zipper, buttons, Velcro, or other means. For example, the material of the shell 18 can be a soft, non-shrinkable fabric with the Velcro attached to the clasping arms. In one embodiment, on the horizontal elements 2 and 2′ there is a zipper attached to the fabric on the bottom with the some horizontal length of the horizontal elements.

In some embodiments, there is an insert 30 comprised of a shell 32 that is stuffed with filling 20. In such embodiments, the shell 18 functions as an outer covering for the device 10 and the insert 30 functions as a stiffener for the device 10. In some embodiments, the insert 30 is a detachable element from the shell 18. In one embodiment, on the horizontal elements 2 and 2′ there is a zipper attached to the fabric on the bottom with the some horizontal length of the horizontal elements. This is to seal and secure the material of the internal insert 10. In some embodiments, the insert 10 consists of the main the upright element 4, horizontal elements 2 and 2′, and clasping arms 6a and 6b. In the insert, there are some differences in the clasping arms which do not touch and do not have Velcro 12a and 12b, this being the insert 10 is inserted inside of shell 18. The shell 32 is a fabric like material that is filled with filling 20 such as polyester or equivalent, to hold the shape and makes elements 2, 4, and 6 and appearance all the way around and provides the support from inside the shell 18.

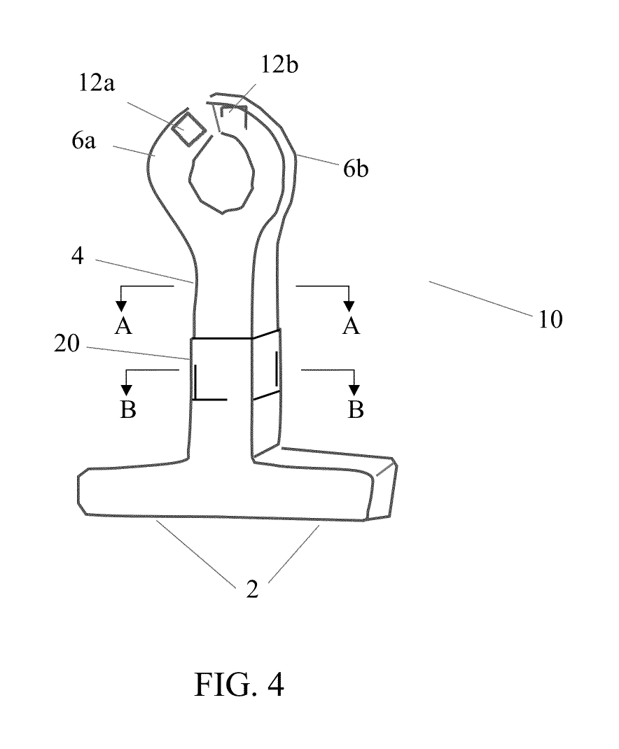

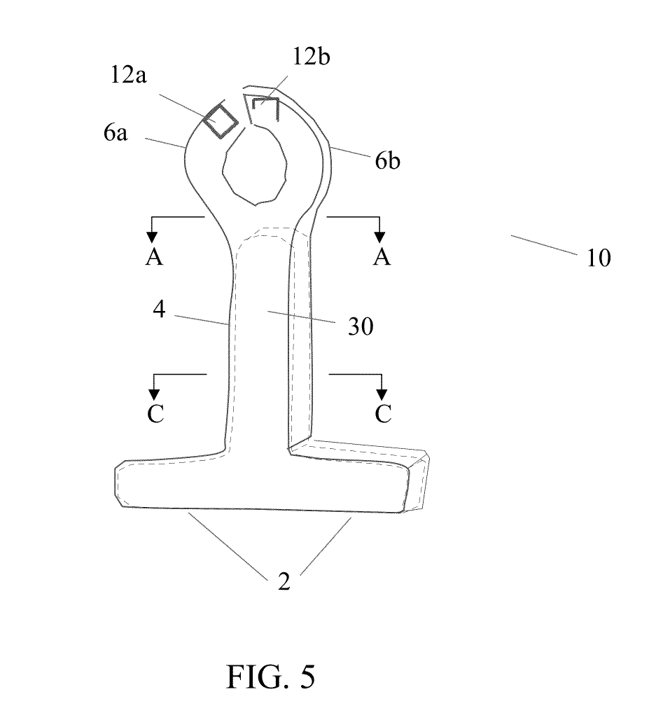

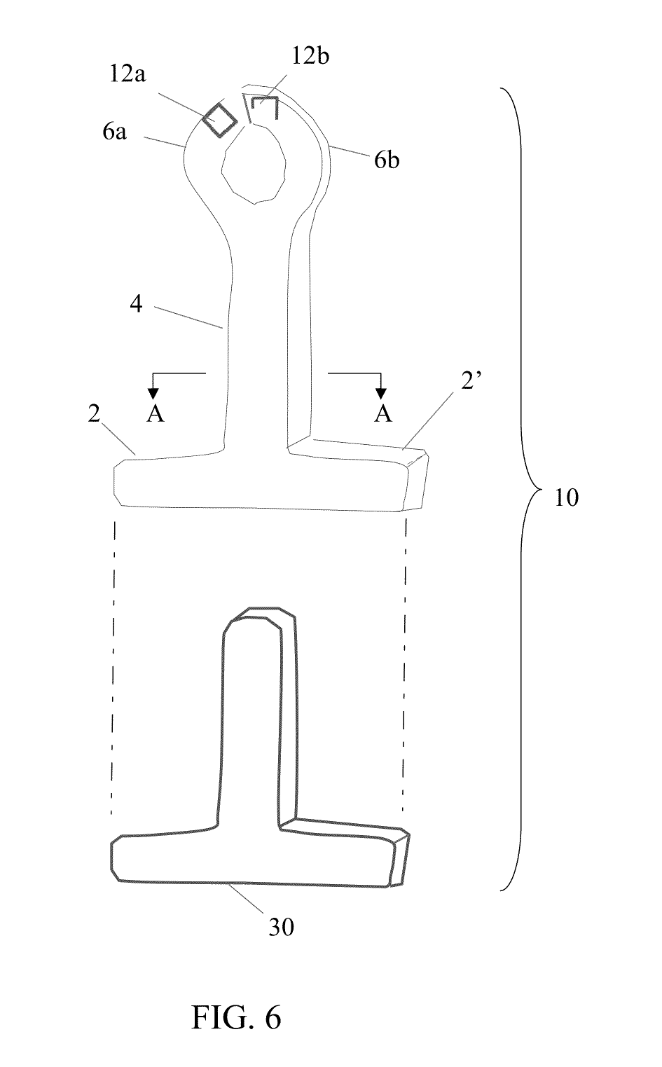

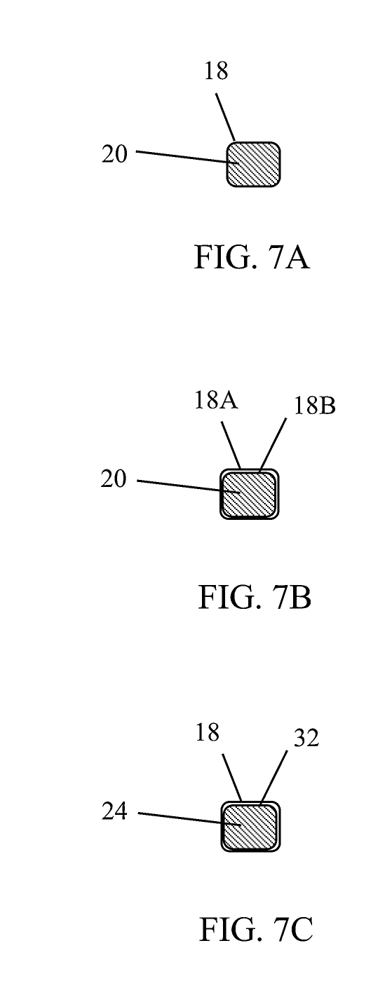

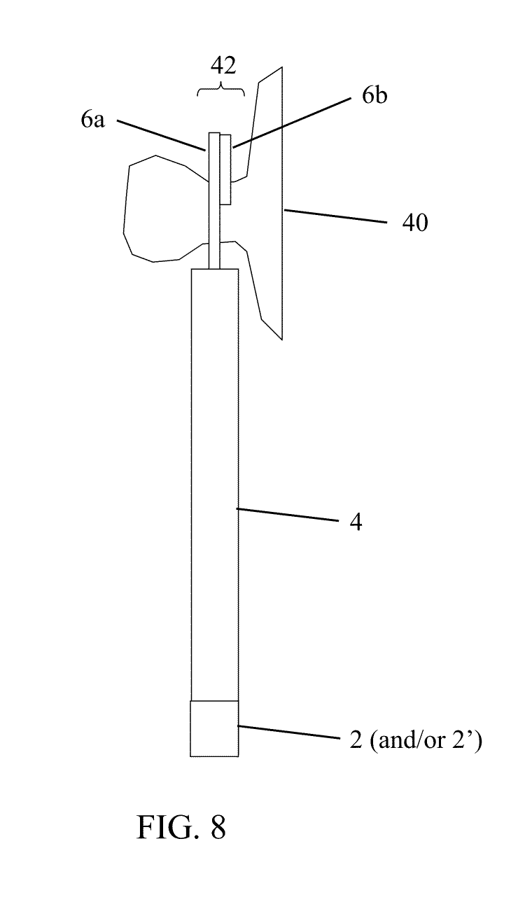

FIGS. 7A, 7B and 7C show the cross-sections of the upright element for alternative embodiments of the invention. FIG. 7A corresponds with cross-section A-A, FIG. 7B corresponds with cross-section B-B, FIG. 7C corresponds with cross-section C-C. FIG. 4 illustrates some embodiments of the invention that are capable of adjustment of the height of the upright element 4 wherein cross-section A-A indicates the portion of the upright element 4 where the shell 18 does not have overlapping fabric and cross-section B-B indicates the portion of the upright element 4 where the shell does have overlapping fabric comprising 18A and 18B. For example, the overlapping fabric may be secured by velcro strips applied to the shell pieces 18A and 18B similar to the clasping arms or by other methods of attachment. FIGS. 5 and 6 illustrate some embodiments of the invention where an insert 30 is capable of being removed from the device 10 wherein cross-section A-A indicates the portion of the upright element 4 where the shell 18 has filling 20 but does not have an insert and cross-section C-C indicates the portion of the upright element 4 that has an insert 30 with its own shell 32 and its own filling 24. For example, the insert 30 can be removed from the outer shell 18 and may be secured by a zipper or by velcro strips attached to opposing sides of an opening where the insert 10 is removed.

In operation, elements 2, 4, 6 and 18 and 20 are necessary for the invention/device to work properly and effectively. In certain embodiments, the insert 30 having a shell 32 and a filling 24 are also necessary. When all of these elements are together, they make up a bottle support system for infants 1 month and older. In the preferred embodiment, this device is put into use by a caretaker by first placing the horizontal elements 2 and/or 2′ under the infant or child's legs. The upright element goes in-between the infants legs where the infant's or child's bottle is placed in the clasping arms 6a and/or 6b, and then secured with use of the Velcro around the neck of the bottle. If necessary, the caretaker then places the infant's nipple of the bottle into the infant's mouth. However, an infant or child who can hold a bottle can reach and pull the bottle toward the infant or child and receive the bottle in his or her mouth without ongoing or repeated assistance from the caretaker.

In other applications of the invention, the caretaker may secure an article of merchandise in the clasping arms 6a and 6b. For example, the article of merchandise could be a teething ring or device that is clasped by the clasping arms within reach of the infant or child. In other examples, the article of merchandise is a toy or stuffed animal, or book, and so on that is clasped by the clasping arms. In still other embodiments, an adapter 40 having a neck 42 is removably attached to the article of merchandise to enable the clasping arms to clasp the adapter and hold the merchandise in front of the infant or child. The adapter can be fabricated to facilitate the article or merchandise, such as a toy, book, puzzle, electronic reader, or video game controller or the like, may be attached with straps, strings, screws, double stick tape, or any means appropriate for the particular article of merchandise.

The bottle support system described can also be used as a neck rest or pillow support in the infant's infant seat. This is possible by placing the bottle support system upside down and placing it on the right or left side of the infant's body above the shoulder. The horizontal element acts like the pillow to support the infant's head.

From the foregoing it will be appreciated that although specific embodiments of the invention have been described herein for purposes of illustration, various modifications may be made without deviating from the spirit and scope of the invention. For example, the cross-sectional shape of the upright element and the number and shape of the clasping arms can vary in different embodiments of the invention. In another example, the invention may be constructed from various resilient materials including woven fabric, vinyl or other plastic sheeting and one or more of the seams may be buttoned, zippered, stitched, glued or welded. Further, the invention can be used with adults, children or infants which are seated upright or partially reclined. Examples of seats may include high chairs, booster seats, car seats, lounge chairs, rocking chairs, couches, and so on. Accordingly, the invention should be broadly construed and should not be limited to the claims as written.

1. A device for holding an article of merchandise within reach of a seated person comprising:
at least one horizontal element situated under at least one leg of the seated person;
an upright element approximately perpendicular to the horizontal element wherein the upright element is comprised of resilient material which just supports the weight of the article of merchandise without buckling such that the article of merchandise may be moved toward the seated person with no or very limited horizontal resistance;
at least a first clasping arm having a first end firmly connected to the upright element and having a second end detachably connected to the upright element itself or to a second clasping arm having an end firmly connected to the upright element; and
wherein the first clasping arm encircles a neck of the article of merchandise or a portion of the article of merchandise which is narrower in diameter or girth than adjacent portions of the.

2. The device of claim 1 wherein the article of merchandise is a bottle, rattle, stuffed animal, toy, or adapter to hold a tangible object having a neck or portion that is narrower in diameter or girth than adjacent portions of the bottle, rattle or toy.

3. The device of claim 1 wherein the article of merchandise is a teether or toy having a loop, hole, or orifice that the clasping arms may pass through when the first clasping arm is removably connected to the second clasping arm.

4. The device of claim 1 wherein the article of merchandise is game controller with a portion that is narrower in diameter or girth that adjacent portions of the game controller.
